(19) United States
(12) Patent Application Publication
(10) Pub. No.: US 2026/0081498 A1
(43) Pub. Date: Mar. 19, 2026

(54) ROTATING ELECTRICAL MACHINE SLOT LINER

(71) Applicant: BorgWarner Inc., Auburn Hills, MI (US)

(72) Inventor: Ben Kang, Noblesville, IN (US)

(21) Appl. No.: 18/884,158

(22) Filed: Sep. 13, 2024

(51) Int. Cl. H02K 3/34; H02K 1/20

(52) U.S. Cl. CPC H02K 3/345; H02K 1/20

(57) ABSTRACT

A slot liner configured for use in a stator assembly of a rotating electrical machine, including a first wall, configured to abut a portion of a stator slot, having a surface that faces the stator windings; a second wall, configured to abut another portion of the stator slot, having a surface that faces the stator windings; an axially extending fluid channel, separated from the stator windings, positioned radially between the stator windings and a back iron area of the stator assembly; and an elongated baffle assembly configured to receive fluid and change the direction of fluid within the slot liner.

### TECHNICAL FIELD

The present application relates to rotating electrical machines and, more particularly, to slot liners used with rotating electrical machines.

### BACKGROUND

Rotating electrical machines, sometimes referred to as electric motors, typically include a rotor assembly received by a stator assembly. The rotor assembly can have a rotor including magnets or rotor windings and an output shaft coupled to the rotor. The stator assembly can include stator windings received within stator slots formed in a substantially annular stator around the circumference of an inwardly facing surface. In some implementations, slot liners formed from a dielectric material can be positioned within the stator slots in between the stator windings and the slots. The rotating electrical machines can be cooled using a fluid that flows over the stator assembly and the rotor assembly. It can be helpful to increase the efficiency with which the fluid cools the rotating electrical machine.

### SUMMARY

In one implementation, a slot liner is configured for use in a stator assembly of a rotating electrical machine, including a first wall, configured to abut a portion of a stator slot, having a surface that faces the stator windings; a second wall, configured to abut another portion of the stator slot, having a surface that faces the stator windings; an axially extending fluid channel, separated from the stator windings, positioned radially between the stator windings and a back iron area of the stator assembly; and an elongated baffle assembly configured to receive fluid and change the direction of fluid within the slot liner.

In another implementation, a slot liner is configured for use in a stator assembly of a rotating electrical machine, including a first wall, configured to abut a portion of a stator slot, having a surface that faces the stator windings; a second wall, configured to abut another portion of the stator slot, having a surface that faces the stator windings; and an elongated baffle assembly, coupled to the surface of the first wall or the surface of the second wall, configured to receive fluid and change the direction of fluid within the slot liner.

In yet another implementation, a slot liner is configured for use in a stator assembly of a rotating electrical machine, including a first wall, configured to abut a portion of a stator slot, having a surface that faces the stator windings; a second wall, configured to abut another portion of the stator slot, having a surface that faces the stator windings; an axially extending fluid channel, separated from the stator windings, positioned radially between the stator windings and a back iron area of the stator assembly; and an elongated baffle assembly, positioned within the axially extending fluid channel, configured to receive fluid and change the direction of fluid within the slot liner.

### BRIEF DESCRIPTION OF THE DRAWINGS

FIG. 1 is a perspective view depicting an implementation of a rotating electrical machine including a slot liner;

FIG. 2 another perspective view depicting an implementation of a rotating electrical machine including a slot liner;

FIG. 3 a cross-sectional view depicting an implementation of a rotating electrical machine including a slot liner;

FIG. 4 is a profile view depicting a portion of an implementation of a rotating electrical machine including a slot liner;

FIG. 5 is a perspective view depicting a portion of an implementation of a rotating electrical machine including a slot liner;

FIG. 6 is a perspective view depicting a portion of an implementation of a rotating electrical machine including a slot liner;

FIG. 7 is a profile view depicting a portion of an implementation of a rotating electrical machine including a slot liner;

FIG. 8 is a cross-sectional view depicting a portion of an implementation of a rotating electrical machine including a slot liner;

FIG. 9 is a cross-sectional view depicting a portion of an implementation of a rotating electrical machine including a slot liner;

FIG. 10 is a perspective, cross-sectional view depicting a portion of an implementation of a rotating electrical machine including a slot liner;

FIG. 11 is a cross-sectional view depicting a portion of an implementation of a rotating electrical machine including a slot liner;

FIG. 12 is a perspective view depicting a portion of an implementation of a slot liner configured for use in a rotating electrical machine;

FIG. 13 is a perspective view depicting a portion of another implementation of a slot liner configured for use in a rotating electrical machine;

FIG. 14 is a graph depicting performance of an implementation of a rotating electrical machine; and

FIG. 15 is a graph depicting performance of an implementation of a rotating electrical machine.

### DETAILED DESCRIPTION

A rotating electrical machine includes a stator assembly and a rotor assembly received by the stator assembly. The stator assembly includes stator or field windings that receive electrical current and induce the angular displacement of the rotor assembly with respect to the stator assembly. The rotating electrical machine can generate a significant amount of heat, especially through the stator windings in response to electrical current flow. Elevated levels of heat can reduce the power output of the rotating electrical machine. The rotating electrical machine can be cooled using a fluid passing over and/or through the machine. In some implementations, the stator assembly includes a water jacket, positioned over an outer surface of a stator, that receives fluid and passes the fluid over the outer surface of the stator. It is possible to direct a portion of the fluid from the outer surface of the stator into stator slots to facilitate cooling of the stator. However, depending on the fluid pathway of the fluid, the convective cooling effect on the windings may be limited. For instance, a linear fluid path extending from one radial side of the stator to another side of the stator may create a thermal boundary layer proximate the stator windings thereby limiting the cooling effect provided by the flowing fluid.

In contrast, the rotating electrical machine can use a slot liner positioned within slots of a stator. The slot liner can receive the stator windings of the rotating electrical machine and have a separate fluid pathway, apart from the stator windings, extending within the slot liner in an axial direction parallel to the axis of rotor rotation, with a turbulator positioned within the fluid pathway to agitate and mix the fluid flowing through the fluid pathway thereby minimizing a temperature gradient within a cross-section of the fluid pathway. The fluid pathway within the slot liner can be positioned radially between the stator windings and the back iron of the stator. The turbulator can be a shaped elongated physical element that impedes and/or directs the flow of fluid within the fluid pathway in a non-linear way as the fluid flows long the fluid pathway.

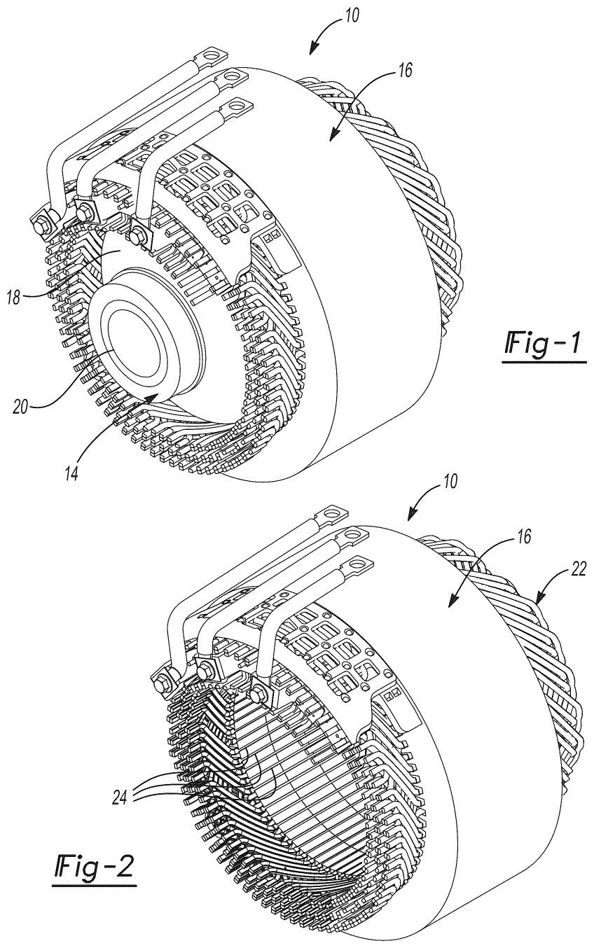

FIGS. 1 and 2 show an implementation of a rotating electrical machine 10 (sometimes referred to as an electric motor). The rotating electrical machine 10 includes a housing (not shown), a rotor assembly 14, and a stator assembly 16. The rotor assembly 14 is mostly located and supported within the stator assembly 16. The rotor assembly 14 includes a rotor 18 that is configured to receive an output shaft (not shown). The rotor 18 can be formed from a number of laminated sheets of iron that are stacked axially along the axis of shaft rotation (x) and bonded together to form the rotor 18. The output shaft can be press-fit into an inner diameter 20 of the rotor 18 to prevent the angular displacement of the output shaft relative to the rotor 18, and a portion of the shaft can protrude out of the housing. The stator assembly 16 is located and supported within the housing. The stator assembly 16 can include laminations that are stacked axially together and bonded to form the shape of the stator, including stator slots. The stator can receive stator linings within stator slots 24 and the selective flow of electrical current through stator windings 22 can induce angular movement of the rotor assembly 14 relative to the stator assembly 16.

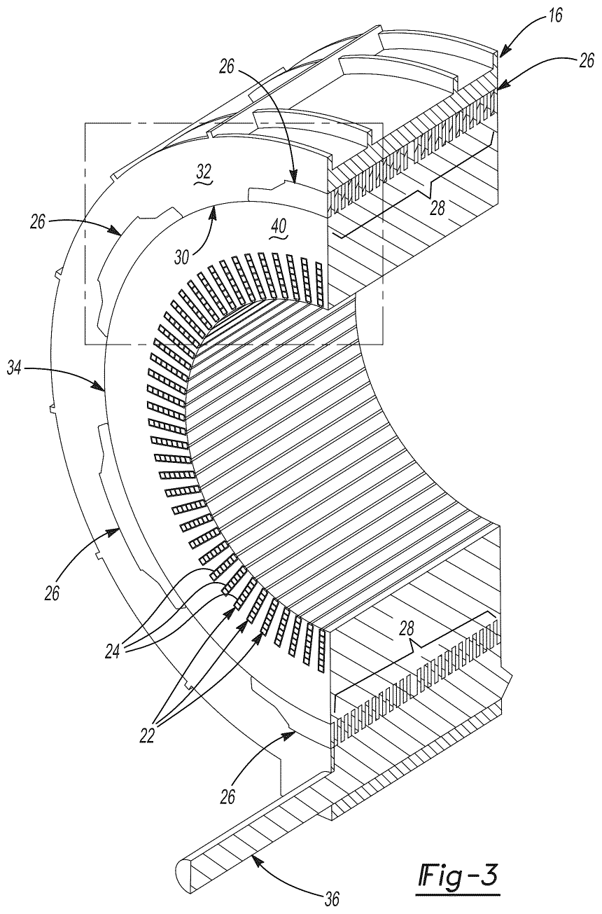

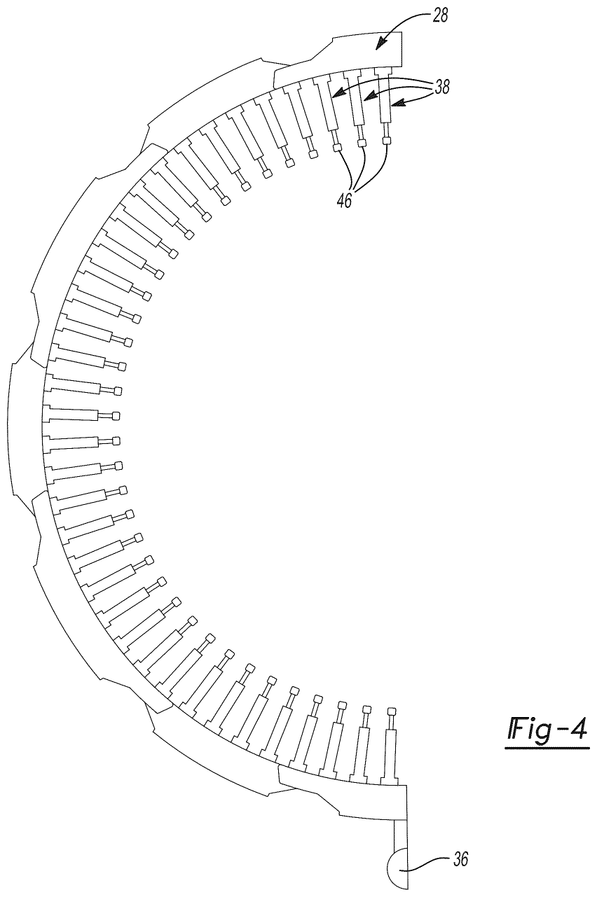

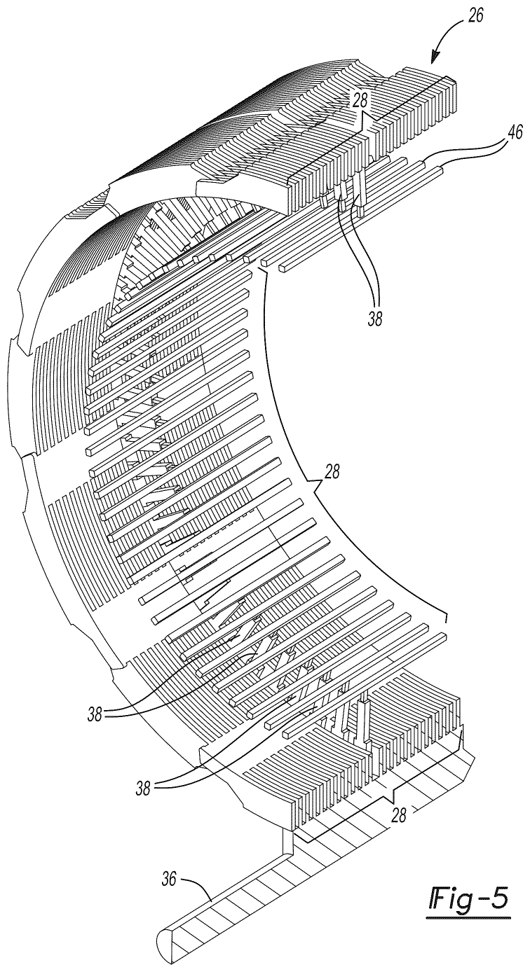

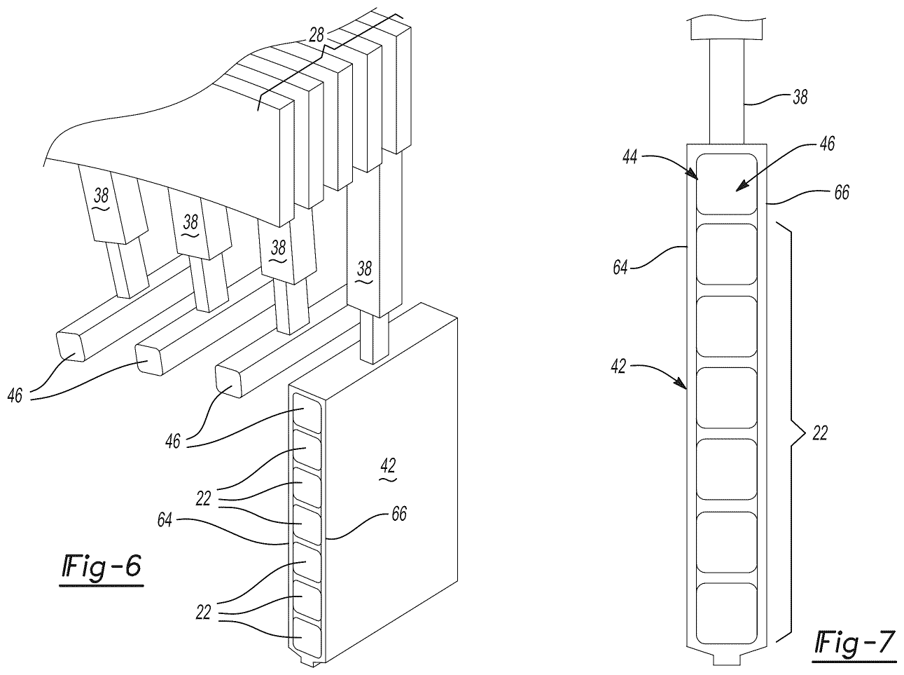

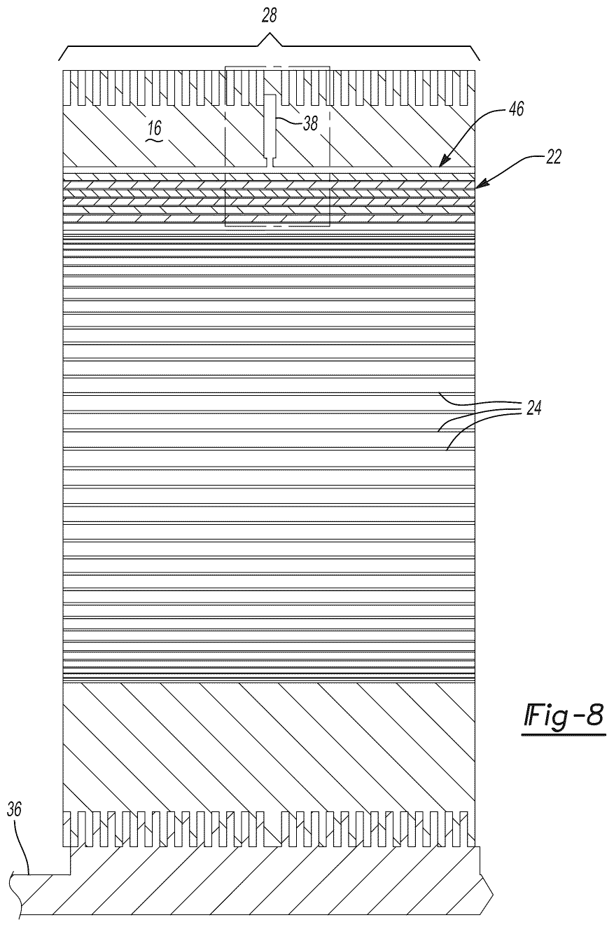

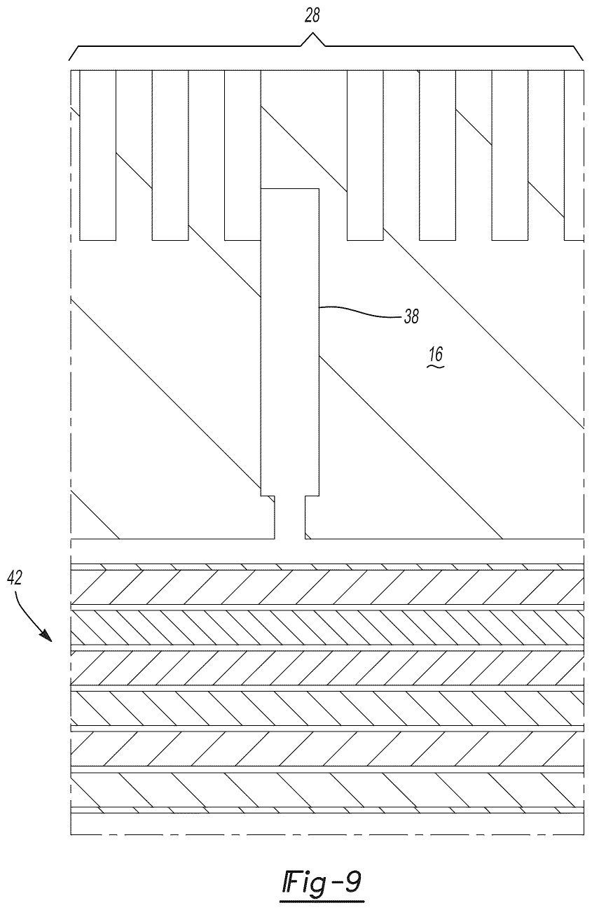

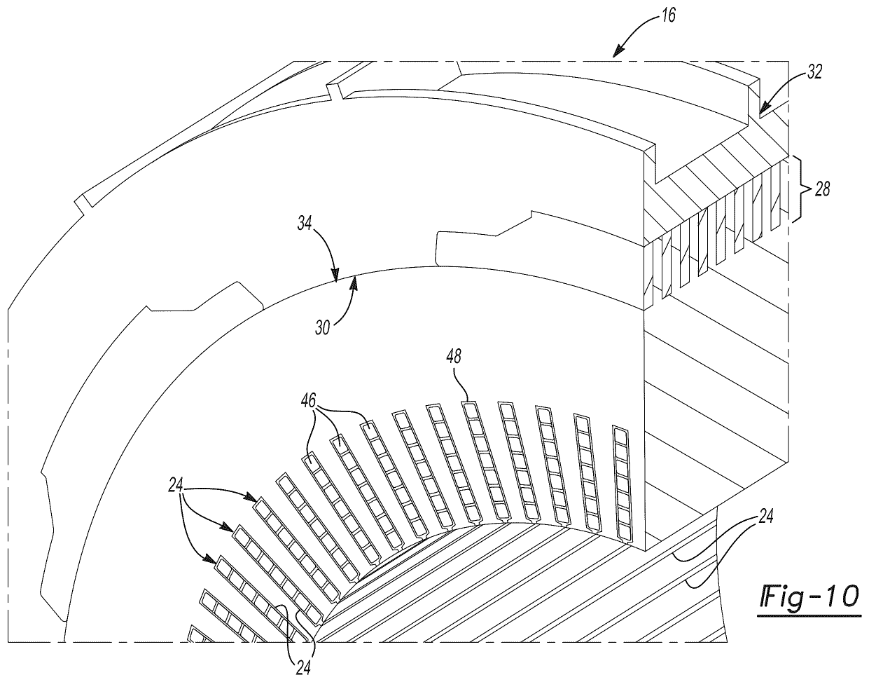

FIGS. 3-10 depict an implementation of the stator assembly including a fluid jacket cooling system 26. The fluid jacket cooling system 26 can receive a fluid from a fluid source (not shown), flow the fluid around an outer surface of the stator assembly 16, and communicate fluid radially-inwardly to a plurality of stator slots 24 within the stator assembly 16. The fluid jacket cooling system 26 can include a plurality of fluid channels 28 extending around the circumference of, and formed adjacent, an outer surface 30 of the stator assembly 16. A tubular housing 32 can be received over the outer surface of the stator assembly 16 such that the tubular housing 32 is positioned concentrically, and radially-outwardly from the axis of rotor rotation (x), with respect to the stator assembly 16 so that an inner surface or diameter 34 of the tubular housing 32 at least partially forms part of the plurality of fluid channels 28 and confines fluid between the inner diameter of the tubular housing and the outer surface 30 of the stator assembly 16. An outer diameter of the tubular housing 32 can be sized and shaped to be received and fit closely within the housing of the rotating electrical machine 10. A fluid input 36 is in fluid communication with a fluid source and receives a pressurized fluid that flows through the fluid input to the fluid channels formed around the circumference of the stator assembly 16 to remove heat from the rotating electrical machine 10 and reduce the overall temperature of the machine 10. In one implementation, the fluid can be a water-ethylene-glycol (WEG) fluid. However, other fluids are possible, such as vehicular fluids commonly used for vehicular lubrication, such as vehicle engine oil or vehicle gear/transmission lubricants.

The stator assembly 16 can include a plurality of radial fluid pathways 38 that extend from the fluid channels 28 to the stator slots 24. The radial fluid pathways 38 can be positioned at a midpoint between end faces 40 of the stator assembly 16 and extend radially-inwardly from the fluid channels 28 through the stator assembly 16 to the stator slots 24. The radial fluid pathways 38 can be angularly positioned so that each radial fluid pathway 38 aligns with a stator slot 26, such that the radial fluid pathways 38 are spaced around the circumference of the stator assembly 16. Fluid can flow radially-inwardly from the fluid channels 28 towards the stator slots 24 through the radial fluid pathways 38.

The stator slots 24 are positioned around the circumference of an inner diameter of the stator assembly 16 and sized to receive slot liners 42 that are positioned in between the stator slots 24 and the stator windings 22. The slot liners 42 can include a cavity 44, configured to receive and closely conform to the stator windings 22, and an axially extending fluid channel 46 in fluid communication with the radial fluid pathways 38. The cavity 44 can include a first wall 64 and a second wall 66 configured to abut portions of the stator slots 24. The first wall 64 and second wall 66 can extend from the back iron area 48 of the stator assembly 16, the axially extending fluid channel 46, toward an inner diameter of the stator assembly 16. The cavity 44 can be closed at the inner diameter of the stator assembly 16 to constrain the stator windings 22 within the stator slot 24. The axially extending fluid channel 46 can include an aperture permitting fluid to flow from the radial fluid pathways 38 into the axially extending fluid channel 46. As the fluid flows into the axially extending fluid channel 46, the fluid can then be guided in opposite directions to the end faces 40 of the stator assembly 16. The slot liners 42 can be formed from any one of a variety of different electrically insulating yet thermally conductive material. The slot liners 42 can be press fit into the stator slots 24 prior to winding the stator windings 22 into the stator slots 24 of the stator assembly 16. The stator windings 22 can be arranged in the stator slots 24 in any one of a variety of ways. For example, the stator windings can be hairpin windings or cascading windings, to name a couple of techniques for forming stator windings. In this implementation, the cavity 44 can receive six stator windings 22 per stator slot 24. The axially extending fluid channel 46 can be integrally formed with the slot liners 42 such that the axially extending fluid channel 46 is radially positioned in between the stator windings 22 within the cavity 44 and the back iron area of the stator assembly 16. In this implementation, the cavity 44 may be isolated from the fluid flowing within the axially extending fluid channel 46 and also closed at a radially-inward end. It is possible to form the slot liners 42 in any one of a variety of ways, such as extrusion.

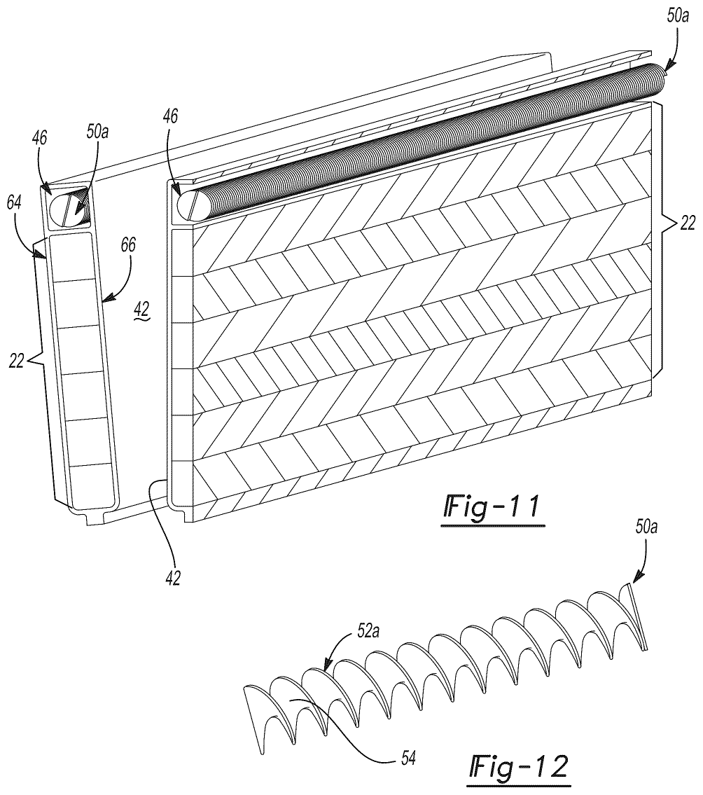

Turning to FIGS. 11-12, an elongated baffle assembly 50a, sometimes referred to as a turbulator, can be positioned within the axially extending fluid channel 46 to disrupt an axial flow of fluid and mix fluid within the axially extending fluid channel 46 to disrupt the existence of a thermal boundary layer within the axially extending fluid channel 46. Given a length of axially extending fluid channel 46 that is greater than five times the diameter of the axially extending fluid channel 46, a noticeable thermal boundary layer can exist without an elongated baffle assembly. The inclusion of an elongated baffle assembly in the axially extending fluid channel can disrupt the thermal boundary layer within the axially extending fluid channel. The elongated baffle assembly 50a can include a fluid guide 52a that interrupts or redirects an axial flow of fluid within the axially extending fluid channel 46. The fluid guide 52a can be formed and/or shaped in any one of a variety of ways. In one implementation, the fluid guide 52 can be formed from a curved planar surface 54 that extends substantially the entire length of the fluid guide 52a. The curved planar surface 54 could be implemented with a shape similar to an Archimedes screw.

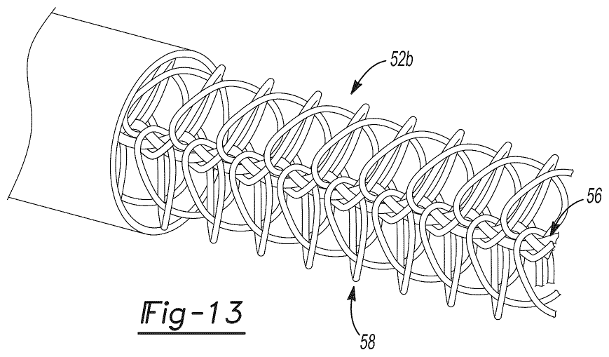

In another implementation, the elongated baffle assembly 50b shown in FIG. 13 can include an elongated body 56 extending substantially the length of the axially extending fluid channel 46. Extending radially outwardly from the elongated body 56 a plurality of wire strands 58 can encircle or circumferentially surround the elongated body 56. Positioned within the axially extending fluid channel 46, the plurality of wire strands 58 can disrupt, impede, and/or mix the fluid flowing through the axially extending channel 46.

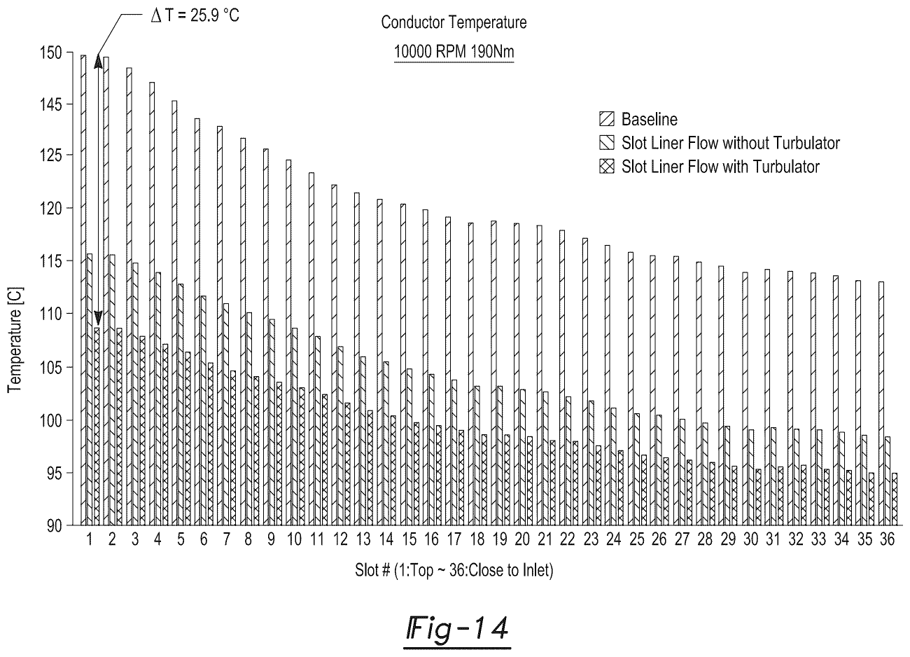

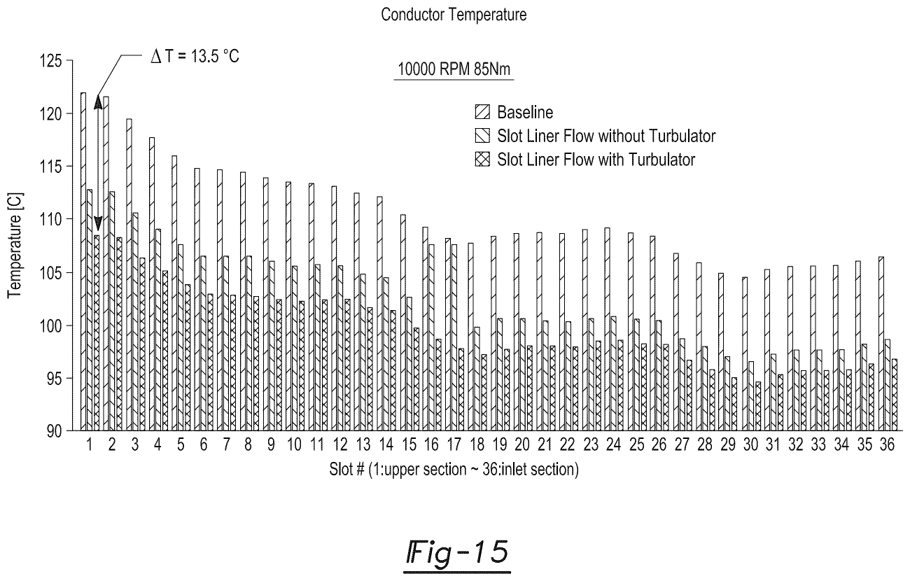

FIGS. 14-15 include graphs depicting rotating electrical machines operating in three different configurations: 1) without an axially extending fluid channel in the stator slot; 2) with an axially extending fluid channel in the stator slot, but without an elongated baffle assembly; and 3) with an axially extending fluid channel and an elongated baffle assembly within the axially extending fluid channel. Fluid temperatures were measured as the fluid flows from a fluid input as the fluid flows through the stator assembly in each of the three configurations. FIG. 13 depicts the rotating electrical machine operating at 10000 RPM and 190 Nm of torque while FIG. 13 depicts the rotating electrical machine operating at 10000 RPM and 85 Nm of torque. In FIG. 13, the temperature difference between the implementation with both the axially extending fluid channel and the elongated baffle assembly and the implementation without either operating at 190 Nm of torque yielded a temperature reduction difference of 25.9 degrees C., while the temperature difference between the implementation with both the axially extending fluid channel and the elongated baffle assembly and the implementation without either operating at 85 Nm of torque yielded a temperature reduction difference of 13.5 degrees C.

Table 1 included below indicates the stator loss, total loss, and efficiencies of a stator without the stator slot, a stator with a stator slot but without a turbulator, and a stator with a stator slot and a turbulator. Table 2 depict torque values measured with a rotating electrical machine including the stator slot with a turbulator and without such a slot and turbulator.

TABLE 1

| | | Slot Flow | Slot Flow |
|---|---|---|---|
| | Baseline | (No Turb) | (with Turb) |
| Stator Loss [W] | 1692.39 | 1600.22 | 1568.83 |
| Total Loss [W] | 3519.00 | 3426.83 | 3395.44 |
| Efficiency [%] | 84.97 | 84.97 + 0.34 | 84.97 + 0.44 |

TABLE 2

| 5000 RPM | Baseline | Slot Flow |
|---|---|---|
| Torque (Nm) | 188.57 | 208.87 |
| Ir (A) | 207.00 | 240.12 |
| T Max (C.) | 180.97 | 182.98 |
| Δ Torque (Nm) | | 20.29 |
| Efficiency (%) | 95.04 | 95.21 |

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A slot liner configured for use in a stator assembly of a rotating electrical machine, comprising:
a first wall, configured to abut a portion of a stator slot, having a surface that faces the stator windings;
a second wall, configured to abut another portion of the stator slot, having a surface that faces the stator windings;
an axially extending fluid channel, separated from the stator windings, positioned radially between the stator windings and a back iron area of the stator assembly; and
an elongated baffle assembly configured to receive fluid and change the direction of fluid within the slot liner.

2. The slot liner recited in claim 1, wherein the axially extending fluid channel is in fluid communication with a water jacket cooling system carried by the stator assembly.

3. The slot liner recited in claim 1, wherein the axially extending fluid channel receives a vehicular lubricant.

4. The slot liner recited in claim 1, wherein the slot liner received fluid at the axially extending fluid channel in between end faces of the stator and fluid flows in opposite directions within the axially extending fluid channel.

5. The slot liner recited in claim 1, wherein the elongated baffle assembly comprises a curved planar surface.

6. The slot liner recited in claim 1, wherein the elongated baffle assembly comprises one or more wires.

7. The slot liner recited in claim 1, wherein the elongated baffle assembly includes a plurality of protuberances.

8. The slot liner recited in claim 1, wherein the elongated baffle assembly includes a continuous raised rib.

9. A slot liner configured for use in a stator assembly of a rotating electrical machine, comprising:
a first wall, configured to abut a portion of a stator slot, having a surface that faces the stator windings;
a second wall, configured to abut another portion of the stator slot, having a surface that faces the stator windings; and
an elongated baffle assembly, coupled to the surface of the first wall or the surface of the second wall, configured to receive fluid and change the direction of fluid within the slot liner.

10. The slot liner recited in claim 9, wherein the axially extending fluid channel is in fluid communication with a water jacket cooling system carried by the stator assembly.

11. The slot liner recited in claim 1, wherein the axially extending fluid channel receives a vehicular lubricant.

12. The slot liner recited in claim 9, wherein the slot liner received fluid at the axially extending fluid channel in between end faces of the stator and fluid flows in opposite directions within the axially extending fluid channel.

13. The slot liner recited in claim 9, wherein the elongated baffle assembly includes a plurality of protuberances.

14. The slot liner recited in claim 9, wherein the elongated baffle assembly includes a continuous raised rib.

15. A slot liner configured for use in a stator assembly of a rotating electrical machine, comprising:
a first wall, configured to abut a portion of a stator slot, having a surface that faces the stator windings;
a second wall, configured to abut another portion of the stator slot, having a surface that faces the stator windings;
an axially extending fluid channel, separated from the stator windings, positioned radially between the stator windings and a back iron area of the stator assembly; and
an elongated baffle assembly, positioned within the axially extending fluid channel, configured to receive fluid and change the direction of fluid within the slot liner.

16. The slot liner recited in claim 15, wherein the axially extending fluid channel is in fluid communication with a water jacket cooling system carried by the stator assembly.

17. The slot liner recited in claim 15, wherein the axially extending fluid channel receives a vehicular lubricant.

18. The slot liner recited in claim 15, wherein the slot liner received fluid at the axially extending fluid channel in between end faces of the stator and fluid flows in opposite directions within the axially extending fluid channel.

19. The slot liner recited in claim 15, wherein the elongated baffle assembly comprises a curved planar surface.

20. The slot liner recited in claim 15, wherein the elongated baffle assembly comprises one or more wires.
